(19) United States
(12) Patent Application Publication
(10) Pub. No.: US 2006/0077648 A1
(43) Pub. Date: Apr. 13, 2006

(54) Lamp having an integral lamp

(75) Inventor: Roland Stark, Wellheim (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 11/241,970

(22) Filed: Oct. 4, 2005

(30) Foreign Application Priority Data
Oct. 11, 2004 (DE) 102004049500.9

(51) Int. Cl. G03B 15/02; H01J 5/48

(52) U.S. Cl. 362/10; 313/318.09

(57) ABSTRACT

The subject of the disclosure is a lamp in which an integral lamp is electrically and mechanically connected to a base via connecting means. These connecting means are preferably designed in the form of clips and are substantially completely surrounded by the base and an outer bulb such that the lamp can have the form of a conventional incandescent lamp and the connecting means are pushed visually into the background such that even stringent aesthetic requirements can be met.

### TECHNICAL FIELD

The invention relates to a lamp having an integral lamp in accordance with the precharacterizing clause of patent claim 1, connecting means in accordance with the precharacterizing clause of patent claim 8 and a method for producing such a lamp in accordance with the precharacterizing clause of patent claim 20.

### BACKGROUND ART

Halogen incandescent lamps are increasingly used in many sectors of daily life owing to their high light quality and long life. It has even become desirable to replace conventional incandescent lamps operating using the system voltage with halogen incandescent lamps even in applications having stringent requirements in terms of aesthetics and economy. For these reasons, lamps having inserted halogen incandescent lamps have been developed which are surrounded by an outer bulb and can therefore barely be distinguished in terms of outward appearance from conventional incandescent lamps.

Such a lamp is described on the Internet domain www.osram.de under the product name “HALOLUX® CLASSIC”. In these lamps, a halogen integral lamp with a pinch seal at one end is held by a bracket provided with a holding wire, and the two power supply lines of the halogen integral lamp are welded to power supply wires. The holding wire and the power supply wires are connected to the outer bulb using the fuse-sealing technique, i.e. the holding wire and the power supply wires are fused with the outer bulb, and the resulting unit is adhesively bonded into a screw base using adhesive or cement.

US 2005029918 A1 discloses a lamp having a similar design, in which a halogen integral lamp having a pinch seal at one end is inserted into a bracket element held by a holding wire or a power supply wire and is surrounded by an outer bulb. The connection of the holding wire or the power supply wire to the outer bulb takes place using the fuse-sealing technique explained above.

Disadvantages with these lamps are firstly the fact that the technique for joining the halogen integral lamp and the base cannot necessarily be automated owing to the fuse-sealing technique and secondly the fact that the halogen integral lamp connected to the base has a relatively high physical height with reduced cold impact strength. Furthermore, it became desirable to design the lamp to be of better quality and more sophisticated in order to satisfy even stringent requirements as regards aesthetics.

In order to simplify the joining technique, U.S. Pat. No. 6,075,318 A discloses a halogen lamp having a lampholder, the halogen lamp being held such that it can be removed in a multi-part, nonconductive adaptor having dedicated power supply sections arranged therein. This solution makes it possible for the lamp to be mounted without using the fuse-sealing technique, but requires a complex, multi-part design and a relatively high physical height of the lamp. The visible adaptor also does not satisfy the stringent requirements placed on the up-to-date design of the lamp.

### DISCLOSURE OF THE INVENTION

The invention is based on the object of providing a lamp having an integral lamp, in particular a halogen integral lamp, suitable connecting means, and a method for producing the lamp, in the case of which an improved method of holding the integral lamp is made possible compared with conventional solutions.

This object is achieved by a lamp, having an integral lamp, in particular a halogen integral lamp, which is inserted into a base and is surrounded by an outer bulb, the base and the integral lamp being connected via connecting means, said connecting means comprising a mounting clip made from an electrically conductive material or having an electrically conductive coating, into which the integral lamp is inserted and in which the integral lamp is electrically and mechanically connected to the base, the mounting clip being surrounded jointly by the base and the outer bulb.

The lamp according to the invention has an integral lamp, in particular a halogen lamp which has a pinch seal at one end, is inserted into a base and is surrounded by an outer bulb. According to the invention, the integral lamp is inserted into an electrically conductive mounting clip and electrically and mechanically connected to the base of the lamp via said mounting clip. This mounting clip takes on the function both of making electrical contact with and mechanically fixing the integral lamp such that separate power supply lines, as are required in the solution described in U.S. Pat. No. 6,075,318, can be dispensed with, and the complexity in terms of apparatus is considerably reduced compared with this solution. In accordance with the invention, the mounting clip is surrounded by the base and the outer bulb and thus does not disrupt the lamp design.

Owing to the mounting clip, the integral lamp can be fixed without using the fuse-sealing technique, with the result that it is possible for the integral lamp to be held in a more stable manner and the cold impact strength is considerably improved compared with conventional solutions. The production of the lamps is likewise considerably simplified compared to the generic methods since the separate working steps for forming the fuse seal can be dispensed with.

In accordance with a particularly preferred exemplary embodiment, the integral lamp used has two power supply lines, a first power supply line being electrically connected directly to the mounting clip, and a second power supply line being electrically connected to a center contact of the base of the lamp via a power supply wire, the first power supply line preferably being welded or soldered to an outer wall of the mounting clip.

It has proven to be particularly advantageous to fix the integral lamp in the mounting clip also with at least two spring lugs which are preferably integral with the connecting clip and which make it easier for the integral lamp to be positioned and held in the connecting clip.

In the case of screw bases having an inner diameter which is similar to the outer diameter of the mounting clip (for example E14 or E12 screw bases), the mounting clip can be screwed into the base via screw-in projections on the circumference side. With this variant, the mounting clip is thus screwed directly into the base once the integral lamp has been inserted, and the outer bulb is then positioned.

Alternatively, the mounting clip can also be compressed by the base. This variant is used in particular in the case of larger bases (for example E27 base), in this case a transition clip being positioned on the mounting clip and then being compressed by the base.

In one advantageous solution, the mounting clip used for larger screw bases has a circumferential wall which surrounds a section of the outer bulb and is surrounded by a base sleeve.

In order to connect the unit comprising the mounting clip and the transition clip to the base of the lamp in a force-fitting manner, it is preferred to form spring claws, which are bent out for the purpose of engaging in a pot-shaped connecting section of the base, in apertures in the circumferential wall.

In this exemplary embodiment, the bonding compound is preferably introduced into an annular space delimited by the outer bulb and the base, it being possible for the adhesive or cement to be distributed in the annular space via the apertures in the circumferential wall. As a result, a homogeneous connection between the outer bulb, the transition clip and the base is achieved. The bonding compounds used are, for example, paste-like adhesives or cements which contain volatile solvents in addition to resins and fillers, for example cements based on phenolic resin or based on silicone. Curing of the adhesive compound usually takes place thermally along a heating section or in an oven, the processes of evaporation of the solvent, foaming, reaction of resin and curing agents and setting taking place during curing.

The circumferential wall of the transition clip may preferably have an edge which faces the outer bulb and has an extended diameter such that it can be brought to bear against the base sleeve.

In order to delimit the penetration depth when inserting the mounting clip into the base, delimiting elements are preferably arranged on the outer circumference of said base.

The mounting clip has an accommodating section which is approximately in the form of a cylinder casing and is preferably formed by two cutouts which are arranged diametrically in relation to one another and in which a region, which has been flattened so as to be planar-parallel, of a pinch seal of the integral lamp can be accommodated, an extended edge section adjoining the flattened region of the pinch seal coming to lie outside the accommodating section.

In one exemplary embodiment, the cutouts are formed with projections which are arranged diametrically in relation to one another, can be brought to bear against the flattened region of the pinch seal and are provided with insertion bevels with which projections arranged on the pinch seal collide when the integral lamp is inserted. The insertion bevels make it easier to insert the pinch seal when mounting the integral lamp and to delimit the penetration depth of the projections into the mounting clip via the colliding projections.

One method according to the invention for producing such a lamp takes place using the following steps:
a) electrical connection and insertion of the integral lamp into the mounting clip;
b) insertion of the mounting clip into the base;
c) introduction of the bonding compound for the purpose of fixing the relative position of the components;
d) positioning of the outer bulb such that the mounting clip is surrounded by the base and the outer bulb, and
e) curing of the bonding compound.

Before the integral lamp is inserted into the connecting clip, a first power supply line is preferably connected to a power supply wire, and a second power supply line is bent out. This incoming power line is fixed, preferably welded, to the outer wall of the mounting clip once the integral lamp has been inserted into said mounting clip, and thus the integral lamp is positioned and held. The power supply wire is cut to length and center contact soldering is performed.

### BRIEF DESCRIPTION OF THE DRAWINGS

The invention will be explained in more detail below with reference to preferred exemplary embodiments. In the drawing:

FIG. 1 shows a front view of a first exemplary embodiment according to the invention of a lamp;

FIG. 2 shows a side view of the lamp shown in FIG. 1;

FIG. 3 shows a three-dimensional illustration of connecting means of the lamp shown in FIG. 1 with the integral lamp inserted;

FIG. 4a shows a detail illustration of the connecting means shown in FIG. 3;

FIG. 4b shows an illustration of FIG. 4a, rotated through 90°;

FIG. 5 shows another perspective of the connecting means shown in FIG. 3;

FIG. 6 shows a section G-G from FIG. 1;

FIG. 7 shows a view of the detail C from FIG. 1;

FIG. 8 shows a front view of a further exemplary embodiment of a lamp according to the invention;

FIG. 9 shows a sectioned side view of the lamp shown in FIG. 8;

FIG. 10 shows a three-dimensional illustration of a mounting clip of the lamp shown in FIG. 8 with the integral lamp inserted, and

FIG. 11 shows a view of the detail A from FIG. 9.

### BEST MODE FOR CARRYING OUT THE INVENTION

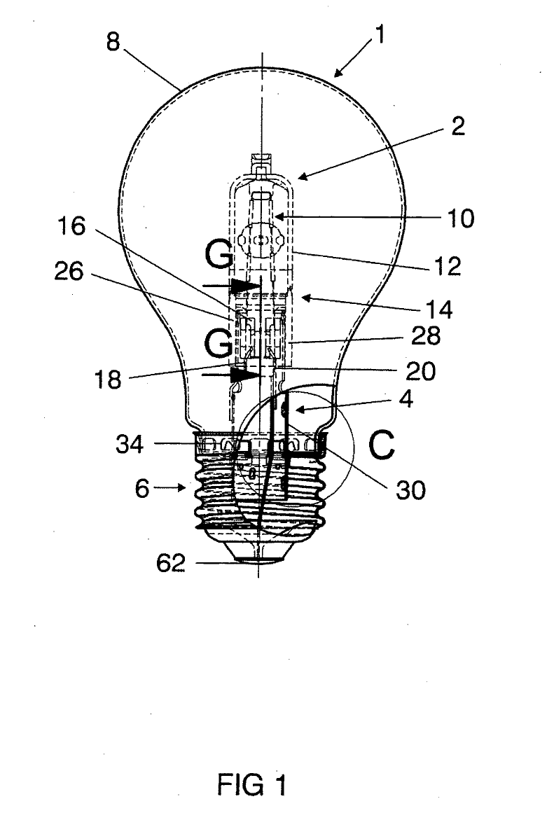

With reference to FIGS. 1 to 7, firstly an exemplary embodiment will be explained of a lamp 1 according to the invention which has the design of a conventional incandescent lamp but emits halogen light.

The lamp 1 has an integral lamp 2 which is mechanically and electrically connected to a base 6 via connecting means 4 and is surrounded by an outer bulb 8. The outer bulbs 8 used may have any bulb shape known from the general prior art (for example drop shape, candle shape, mushroom shape, etc.) or be in the form of a tubular bulb. Depending on the application, frosted, clear or (for increased scattering effect) siliconized or partially siliconized bulbs made from glass are used. In the exemplary embodiment illustrated, the connecting means 4 are designed such that they are substantially completely accommodated in the space surrounded by the outer bulb 8 and the base 6.

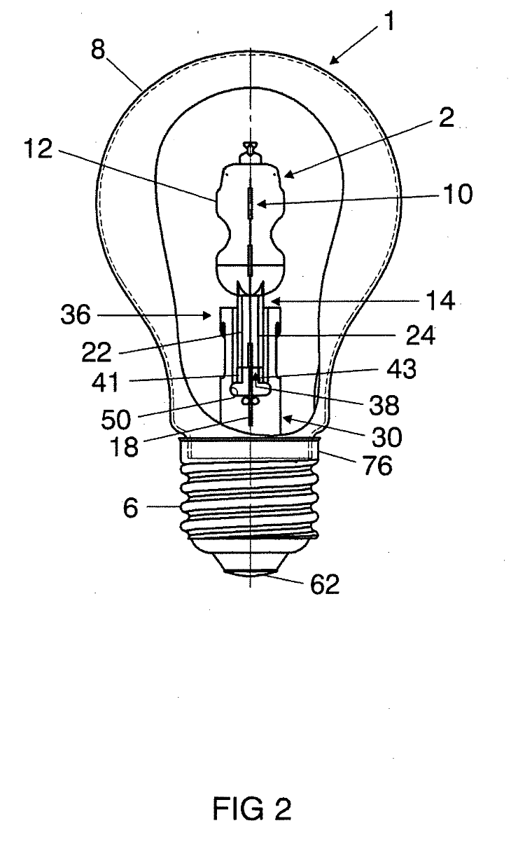

In the exemplary embodiment illustrated, the integral lamp 2 is in the form of a halogen incandescent lamp (halogen burner) having a conventional design. As shown in FIGS. 1 and 2, such a halogen incandescent lamp substantially comprises a filament 10 which is provided, for example, with four filament sections and is fixed in position in a bulb 12 by means of knobs. This bulb 12 is sealed by means of a pinch seal 14 at one end in which the two end sections of the filament 10 are connected to power supply lines 18, 20, passed out of the pinch seal, via in each case one molybdenum foil 16. The pinch seal 14 is designed such that the central region in FIG. 1 is formed with planar-parallel faces 22, 24 (perpendicular to the plane of the drawing in FIG. 2) which merge with edge sections 26, 28 which protrude on both sides beyond the two faces 22, 24 perpendicular to the plane of the drawing in FIG. 1 such that the cross section (not illustrated) of the pinch seal is approximately in the form of a double T with the extended edge sections 26, 28 and the region lying therebetween which is delimited by the two faces 22, 24 which run planar-parallel.

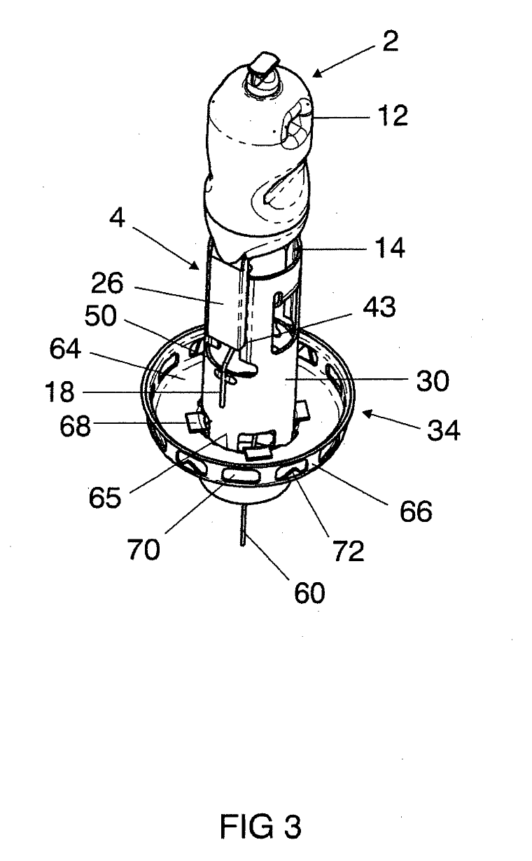

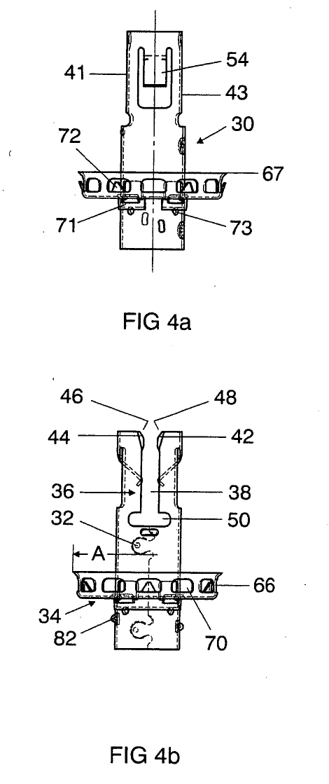

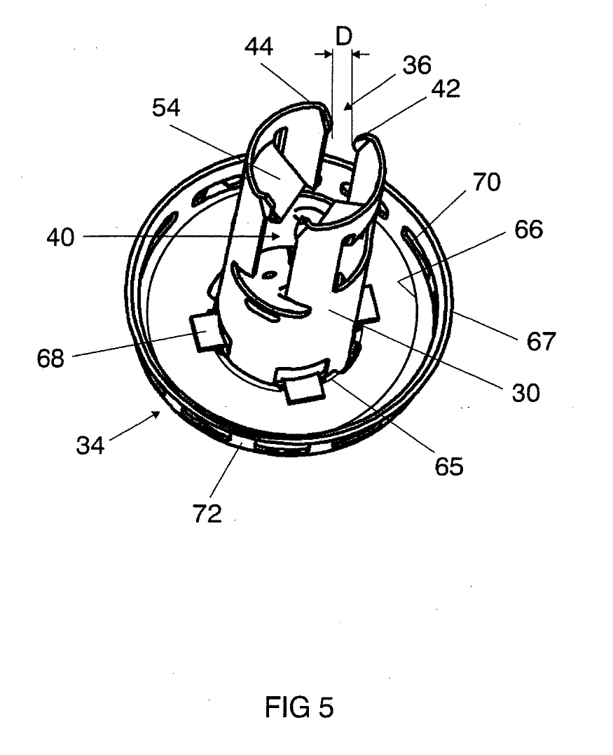

FIG. 3 shows a three-dimensional illustration of the connecting means 4, via which the integral lamp 2 is mechanically and electrically connected to the base 6. This connecting means 4, which is illustrated in FIGS. 4 and 5 without the integral lamp 2 inserted, has a mounting clip 30 which is formed from a stamped sheet metal part into a tube or cylinder casing, said tube or cylinder casing being held together in a force-fitting and interlocking manner by means of engaging elements 32 with a relief cut out illustrated in the FIGS. 4a, 4b. In the exemplary embodiment illustrated, a transition clip 34, whose outer circumference is slightly smaller than the inner circumference of the base 6, is positioned on the outer circumference of the mounting clip 30. In the conventional design, this base (E27, E26) is designed to have a comparatively large diameter such that the diameter difference between the mounting clip 30 and the base 6 is compensated for by the transition clip 34. This will be explained in more detail below.

As can be seen in particular in FIG. 5, the mounting clip 30 has an accommodating section 36 at its end which faces the integral lamp 2 (at the top in FIGS. 3, 4, 5), the pinch seal 14 of the integral lamp 2 being inserted into said accommodating section 36. In the exemplary embodiments described, this accommodating section 36 is formed by two slot-like cutouts 38, 40 arranged diametrically in relation to one another.

The circumferential regions 41, 43, which delimit the cutouts 38, 40, of the mounting clip casing 30 are bent towards one another inwards such that they run approximately perpendicular to the two faces 22, 24 of the pinch seal 14. The cutouts 38, 40 towards the bottom (view shown in FIG. 3) merge with a region 50 which has been extended approximately in the form of an ellipsoid, and this region 50 makes it possible for the circumferential sections 41, 43 of the two cutouts 38, 40 to be bent inwards.

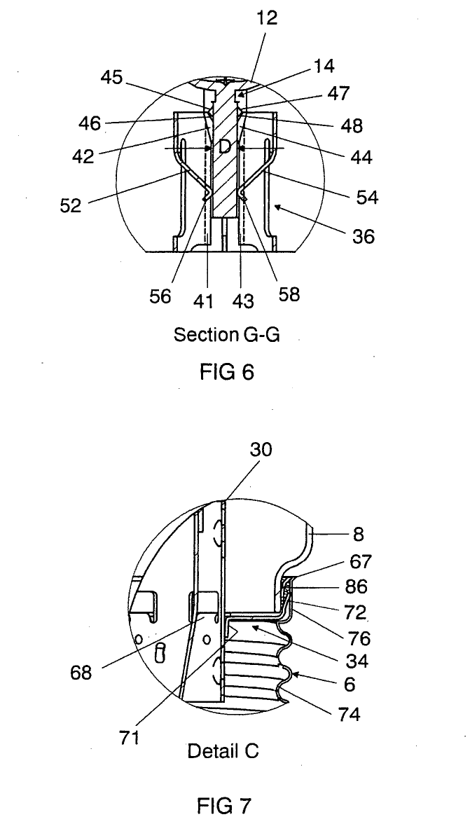

In the region of the circumferential edge of the mounting clip 30 which lies at the top in FIGS. 4 and 5, two projections 42, 44, which are diametrically opposite one another and which each merge, via an insertion bevel 46, 48, with the circumferential edge of the sheet metal casing lying at the top, are formed at each cutout 38, 40. These projections 42, 44 are bent inwards in the same way as the circumferential regions described above or are bent slightly further inwards, the clear width D between the two projections 42, 44 corresponding to the thickness of the pinch seal 14, i.e. the distance between the two planar-parallel faces 22, 24. This dimension is illustrated in the detail illustration shown in FIG. 7 which shows the section G-G in FIG. 1. Accordingly, the projections 42, 44 bear against the planar-parallel faces 22, 24, while the adjoining edges of the cutouts 38, 40 are spaced apart from said planar-parallel faces 22, 24. As shown in FIG. 6, tabs 45, 47, which collide with the insertion bevels 46, 48 when the integral lamp 2 is inserted and thus delimit the penetration depth of the integral lamp 2 into the mounting clip 30, are formed on the two planar-parallel faces 22, 24.

As can be seen in particular in FIG. 3, the bent circumferential sections 41, 43 of the two cutouts 38, 40 engage behind the two projecting edge sections 26, 28 of the pinch seal, which are then arranged outside the mounting clip 30, when the integral lamp 2 is inserted. That is to say, the pinch seal 14 passes through the mounting clip 30 diagonally, the projections 42, 44 of the cutout 38, 40 resting on the faces 22, 24 of the pinch seal 14 such that the integral lamp 2 is fixed in position in the radial direction.

Clamping of the integral lamp 2 takes place by means of the spring lugs 52, 54 (illustrated in the section G-G shown in FIG. 6) which are stamped free when the sheet metal casing is stamped and then bent inwards such that they bear in a resilient manner against the two faces 22, 24 of the pinch seal 14 when the integral lamp 2 is inserted. In order to improve the clamping action and to simplify assembly, the end sections 56, 58 of the two spring lugs 52, 54 are bent back.

When the integral lamp 2 is mounted in the mounting clip 30, the power supply line 18 is bent outwards such that it passes through the cutout 38 and bears against the outer circumference (cf. FIG. 3) of the mounting clip 30. The power supply line 18 is then connected to the mounting clip 30 by means of welding or soldering. As shown in FIG. 1, a power supply wire 60, which protrudes downwards, in the extension of the power supply wire 20, through the interior of the mounting clip 30 into the base 6 and is electrically connected there to a center contact 62 (FIG. 1), is welded to the other power supply line 20. The electrical and mechanical connection of the mounting clip 30 to the base 6 takes place by means of the transition clip 34 which is approximately in the form of a plate in the exemplary embodiment illustrated and, as shown in FIGS. 3 and 5, has a floor 64 which merges with a circumferential wall 66 which surrounds the outer circumference of the mounting clip 30 at a distance. As shown in FIGS. 4a, 4b, the circumferential edge 67 of the circumferential wall 66 is widened in the form of a funnel to a diameter A and is thus matched to the base diameter. This will be explained in more detail below with reference to FIG. 7.

A floor opening 65 is formed in the floor 64 of the transition clip 34, and the mounting clip 30 passes through said floor opening 65. As can be seen in particular in FIG. 4, two wall sections are stamped free in the region of the floor opening 65 in the floor 64 and are bent downwards such that a flange 71 is formed which bears flush against the outer circumference of the mounting clip 30. A few knobs 73 are provided in this region on the mounting clip 30, protrude in the radial direction and bear, with a press fit, against the inner circumferential surface of the flange 71. The penetration depth of the mounting clip 30 is in this case delimited by lug-shaped delimiting elements 68 which are bent out of the casing of said mounting clip 30 and against which the floor 64 bears from below in the mounted state (view shown in FIGS. 3 and 5).

A large number of apertures 70 are formed in the circumferential wall 66, in the exemplary embodiment illustrated a spring claw 72 being provided in every second aperture 70, it being possible for the transition clip 34 to be compressed by the base 6 via said spring claw 72. This connection is illustrated in FIG. 7 which illustrates the detail C in FIG. 1. Accordingly, the base 6 has, adjacent to its screw-in thread 74, an approximately pot-shaped base sleeve 76, whose inner diameter has the above-described diameter A which corresponds to the outer diameter of the circumferential edge 67 or circumferential wall 66. In accordance with the detail C illustrated in FIG. 7, the preassembled unit shown in FIG. 3 comprising the integral lamp 2 and the connecting means 4 is inserted into the base 6 such that the circumferential edge 67, which arches in the form of a funnel, of the circumferential wall 66 of the transition clip 34 bears against the circumferential edge (at the top in FIG. 7) of the base sleeve 76 of the base 6. The spring claws 72 are bent outwards from the apertures 70 and compressed by the inner circumferential wall of the base sleeve 76 such that the base 6 is connected to the transition clip 34.

As shown in FIG. 7, the outer bulb 8 tapers towards the base 6 to form a cylinder casing section 80 whose outer diameter is slightly smaller than the inner diameter of the circumferential wall 66 of the transition clip 34 such that this cylinder casing section 80 is surrounded by the circumferential wall 66 in the installed state. In order to connect the outer bulb 8, the transition clip 34 and the base 6, cement is introduced into the annular space delimited by the cylinder casing section 80 and by the base sleeve 76 of the base 6, it being possible for this cement to be distributed through the apertures 70 in the circumferential wall 66 of the transition clip 34 such that uniform filling of this annular space and, after curing of the cement, a highly fixed connection of these components is ensured.

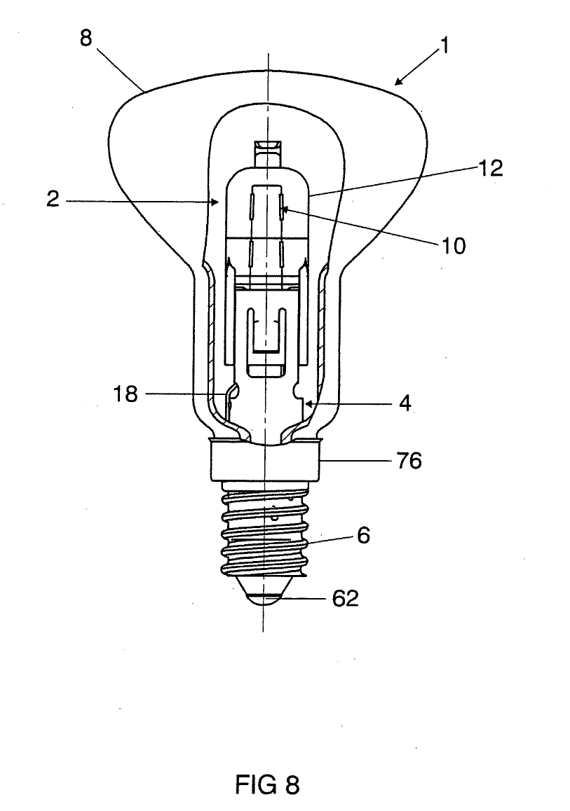

In the exemplary embodiment described above, the transition clip 34 is required in order to compensate for the diameter difference between the mounting clip 30 and the base 6 used. In FIGS. 8 to 11, an exemplary embodiment is illustrated in which the lamp 1 is in the form of an E14 lamp having a smaller base. A halogen burner is used as the integral lamp 2 even in the case of such an E14 lamp, in the exemplary embodiment illustrated the filament 10 having only two filament sections instead of four filament sections in the case of the exemplary embodiment described above. Furthermore, the outer bulb 8 has a shape which is typical of E14 lamps and is inserted into the smaller E14 base 6.

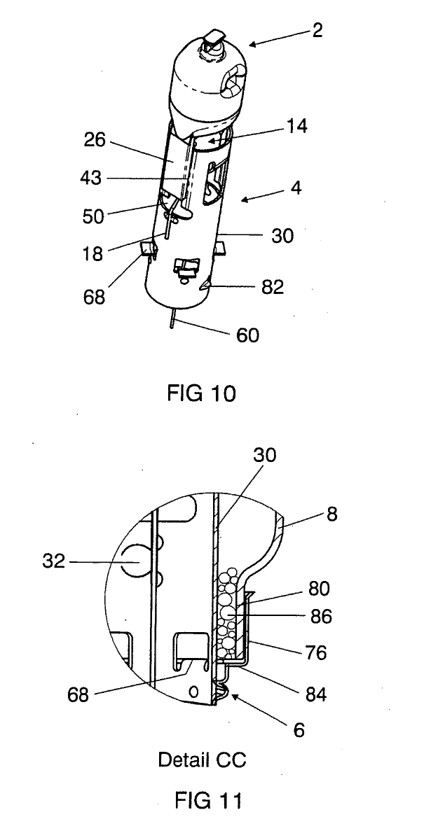

In order to connect the integral lamp 2 to the base 6, in this exemplary embodiment the mounting clip 30 can be used on its own, without the transition clip 34. The preassembled unit comprising the integral lamp 2 and the mounting clip 30 is illustrated in FIG. 10. Accordingly, in this exemplary embodiment, the pinch seal 14 is also inserted into the accommodating section 36 with the two cutouts 38, 40 and is held via the two spring lugs 52, 54. The power supply line 18 is welded to the outer circumference of the mounting clip 30, and the power supply wire 60 is welded to the other power supply line 20 of the integral lamp 2 and protrudes downwards from the mounting clip 30. As regards the details for fixing the integral lamp 2 and for the corresponding design of the mounting clip 30, reference is made to the above-described embodiments relating to FIGS. 3, 4, 5, 6 and 7 in order to avoid repetition.

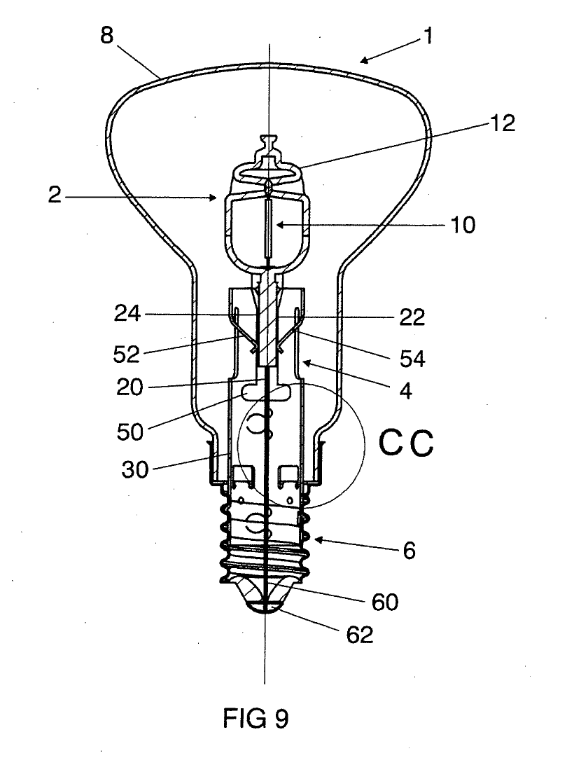

At the lower region of the mounting clip 30, the delimiting elements 68, which are bent out in the radial direction, are likewise provided; furthermore, two or more screw-in projections 82 bulge out of the outer circumference of the mounting clip 30 below the delimiting lugs 68 and lie on a thread pitch which is designed so as to correspond to the thread of the E14 base 6. The mounting clip 30 can be screwed directly into the thread of the base 6 with the aid of these screw-in projections 82, with the result that the connection is made in an extremely simple manner. These screw-in projections 82 are also formed in the exemplary embodiment described above but do not have a function there. As shown in FIGS. 9 and 11, the base 6, as in the case of the exemplary embodiment described above, is designed to have a base sleeve 76 with whose floor surface 84 the lug-shaped delimiting elements 68 collide when the mounting clip 30 is screwed in and thus delimit the screw-in depth. Once the mounting clip 30 has been screwed in, the power supply wire 60 which protrudes downwards is then cut to length and electrically connected to the center contact 62.

As shown in the detail illustration in FIG. 11, the outer bulb 8 is inserted with its cylinder casing section 80 into the base sleeve 76 of the base 6, the annular space surrounded by the mounting clip 30 and by the circumferential wall of the base sleeve 76 being filled with cement 86 or a suitable adhesive prior to insertion. This cement 86 or adhesive is forced slightly inwards when the outer bulb 8 is inserted since the outer circumference of the cylinder casing section 80 bears substantially flush against the inner circumferential wall of the base sleeve 76.

Assembly in the two exemplary embodiments described above is substantially the same. In a first working step, the power supply wire 60 is welded to the power supply line 20 of the integral lamp 2, and the other power supply line 18 is bent back laterally. Then, the integral lamp 2 is inserted into the mounting clip 30 such that the pinch seal 14 passes through the cutouts 38, 40 diagonally and is fixably clamped by means of the spring lugs 52, 54. In a further working step, the bent-out power supply line 18 is welded to the outer circumference of the mounting clip 30.

In the exemplary embodiment shown in FIGS. 1 to 7, the transition clip 34 is then pushed on until it bears against the delimiting elements 68 and is fixed in position by means of the knobs 73. Then, the base 6 is pushed on from below, and the spring claws 72 are compressed by the base sleeve 80. As a result, the outer bulb 8 is then inserted into the transition clip 34 and adhesive or cement is introduced into the annular space between the outer bulb 8 and the base sleeve 76 and is heated in an oven or in a heating section. The power supply wire 60 protruding in the axial direction is cut to length and soldered to the center contact 62.

In the exemplary embodiment shown in FIGS. 8 to 11, the mounting clip 30 is screwed into the base 6 directly, and adhesive or cement is introduced into the annular space between the mounting clip 30 and the base sleeve 80, and then the outer bulb 8 is inserted into the base sleeve 80. Curing of the cement/adhesive and center contact soldering then takes place as in the exemplary embodiment described above.

The integral lamp 2 can be held in a clamping manner in any desired fashion and can be held, for example, on its own by bearing circumferential edges or regions of the cutouts 38, 40 or by suitable attached clips or the like. The term “clip” is understood to mean a connecting element by means of which the integral lamp 2 is held in a force-fitting and/or interlocking manner.

The design according to the invention using the connecting means surrounded by the base and the outer bulb is characterized by having a high aesthetic quality with reduced complexity in terms of manufacturing and is thus superior to conventional solutions.

The subject of the disclosure is a lamp in which an integral lamp is electrically and mechanically connected to a base via connecting means. These connecting means are preferably designed in the form of clips and are substantially completely surrounded by the base and an outer bulb such that the lamp can have the form of a conventional incandescent lamp and the connecting means are pushed visually into the background such that even stringent aesthetic requirements can be met.

1. A lamp, having an integral lamp, in particular a halogen integral lamp, which is inserted into a base and is surrounded by an outer bulb, the base and the integral lamp being connected via connecting means, said connecting means comprising a mounting clip made from an electrically conductive material or having an electrically conductive coating, into which the integral lamp is inserted and in which the integral lamp is electrically and mechanically connected to the base, the mounting clip being surrounded jointly by the base and the outer bulb.

2. The lamp as claimed in claim 1, a first power supply line of the integral lamp being electrically connected to the mounting clip, and a second power supply line being electrically connected to a center contact of the base via a power supply wire.

3. The lamp as claimed in claim 2, the first power supply line being welded to an outer wall of the mounting clip.

4. The lamp as claimed in claim 1, the integral lamp being fixed in the mounting clip with at least two spring lugs.

5. The lamp as claimed in claim 1, the outer bulb and the connecting clip or a transition clip borne by said connecting clip being connected by means of a bonding compound, for example an adhesive, cement or the like.

6. The lamp as claimed in claim 5, the bonding compound being introduced into an annular space which is delimited at least in sections by the outer bulb and the base.

7. The lamp as claimed in claim 1, the mounting clip being screwed into the base or being compressed by said base by means of a transition clip.

8. A connecting means, in particular for the lamp as claimed in claim 1, for electrically and/or mechanically connecting a base to an integral lamp and to an outer bulb surrounding said integral lamp, having a connecting clip which is made from an electrically conductive material or is provided with an electrically conductive coating and which has an accommodating section, approximately in the form of a cylinder casing, for the purpose of inserting the integral lamp and is mechanically and electrically connected to the base.

9. The connecting means as claimed in claim 8, the accommodating section being formed by cutouts which are arranged diametrically in relation to one another and in which a region, which has been flattened so as to be planar-parallel, of a pinch seal of the integral lamp can be accommodated and an extended edge section adjoining the flattened region of the pinch seal comes to lie outside the accommodating section.

10. The connecting means as claimed in claim 9, the cutouts being formed with projections which are arranged diametrically in relation to one another, can be brought to bear against the flattened region of the pinch seal and are provided with insertion bevels with which tabs arranged on the pinch seal collide when the integral lamp is inserted.

11. The connecting means as claimed in claim 8, the accommodating section having spring lugs which are arranged diametrically in relation to one another, are bent out from the accommodating section and between which the pinch seal can be clamped.

12. The connecting means as claimed in claim 8, the connecting clip having screw-in projections which can be brought into threading engagement with the base.

13. The connecting means as claimed in claim 8, having a plate-shaped transition clip which surrounds the outer circumference of the connecting clip and can be connected to the base and the outer bulb.

14. The connecting means as claimed in claim 13, the transition clip having a circumferential wall which surrounds a cylinder casing section of the outer bulb and which is surrounded by a base sleeve of the base.

15. The connecting means as claimed in claim 14, apertures, through which the bonding compound can be distributed, being formed in the circumferential wall.

16. The connecting means as claimed in claim 15, spring claws, which can be bent out for the purpose of connecting the transition clip to the base, being formed in apertures in the circumferential wall.

17. The connecting means as claimed in claim 16, a circumferential edge of the circumferential wall being extended to a diameter such that it can be brought to bear against a base sleeve of the base.

18. The connecting means as claimed in claim 8, having delimiting elements for the purpose of delimiting the penetration depth into the base.

19. The connecting means as claimed in claim 8, the mounting clip being a stamped and bent sheet metal part and having an approximately circular cross section, at least in sections.

20. A method for producing a lamp having an integral lamp which is inserted into a base and is surrounded by an outer bulb, the base and the integral lamp being connected via connecting means, in particular in accordance with claim 8, having the following steps:
a) electrical connection and insertion of the integral lamp into a mounting clip;
b) insertion of the mounting clip into the base;
c) introduction of the bonding compound for the purpose of fixing the relative position of the components;
d) positioning of the outer bulb such that the mounting clip is surrounded jointly by the base and the outer bulb, and
e) curing of the bonding compound.

21. The method for producing the lamp as claimed in claim 20, in which, prior to insertion of the integral lamp into the mounting clip, a power supply line of the integral lamp is connected to a power supply wire, and a second incoming power line is bent out.

22. The method for producing the lamp as claimed in claim 21, in which the second incoming power line is fixed to the outer wall of the mounting clip once the integral lamp has been inserted into said mounting clip, and, after curing of the bonding compound, the power supply wire is cut to length, and center contact soldering is carried out.

23. The method for producing the lamp as claimed in claim 20, in which, once the mounting clip has been inserted into the base, the bonding compound is introduced into an annular space between the outer bulb and the base or between the base and the mounting clip.
